(19) United States
(12) Patent Application Publication
(10) Pub. No.: US 2024/0265552 A1
(43) Pub. Date: Aug. 8, 2024

(54) METHODS AND SYSTEMS FOR OPENING DETECTION AND TRACKING

(71) Applicant: XTEND Reality Expansion Ltd., Tel Aviv (IL)

(72) Inventors: Vladmir Froimchuck, Ramat Gan (IL); Vittorio Zaidman, Rehovot (IL); Erez Nehama, Ramat Gan (IL); Lilach Bitton, Nesher (IL); Ido Abergel, Ramat Gan (IL); Omer Zetlawi, Lehavim (IL); Aviv Shapira, Tel Aviv (IL); Reuven Rubi Liani, Rosh Haayin (IL)

(73) Assignee: XTEND Reality Expansion Ltd., Tel Aviv (IL)

(21) Appl. No.: 18/409,853

(22) Filed: Jan. 11, 2024

Related U.S. Application Data
(60) Provisional application No. 63/385,629, filed on Dec. 1, 2022.

(51) Int. Cl. G06T 7/246; G06T 7/12; G06T 7/13; G06V 10/25; G06V 10/44

(52) U.S. Cl. CPC G06T 7/246; G06T 7/12; G06T 7/13; G06V 10/25; G06V 10/44; G06T 2207/20084; G06T 2207/20132; G06V 2201/07

(57) ABSTRACT

In some embodiments, the present application relates to methods and systems for real-time detection and tracking of potential passages in an environment, including a) detecting one or more passages in one or more frames of image data; b) extracting one or more corners for each of the one or more detected passages; c) tracking one or more points between frames of image data for each of the one or more detected passages in one or more frames of image data; and d) assigning one or more passages detected in a frame of image data to one or more previously-detected passages in a different frame of image data.

### CROSS-REFERENCE TO RELATED APPLICATIONS

This application is a non-provisional to U.S. provisional patent application Ser. No. 63/385,629, titled METHODS AND SYSTEMS FOR OPENING DETECTION AND TRACKING, filed on Dec. 1, 2022 the contents is incorporated in its entirety by this reference.

### FIELD OF THE INVENTION

The present application relates to neural networking methods and systems for detecting openings, and for tracking openings through sequential image frames, for example to facilitate UAV navigation and flight.

### SUMMARY

The present application relates to systems, methods, and computer readable media for detecting openings such as windows and doors, and for tracking the openings through sequential image frames. For example, when an unmanned aerial vehicle (UAV; UAV and drone are used interchangeably herein) with a camera takes images of a building in flight, in order to enter the building it must identify openings in the building. To do so, the present applications describe artificial intelligence methods and systems for detecting openings and tracking them, for example, as a UAV approaches an opening in the building. In this example, the opening detection and tracking is performed using images taken from an imager on the UAV.

In one embodiment, disclosed is a method comprising: a method for real-time detection and tracking of potential passages in an environment, the method comprising a) detecting one or more passages in one or more frames of image data; b) extracting one or more corners for each of the one or more detected passages; c) tracking one or more points between frames of image data for each of the one or more detected passages in one or more frames of image data; and d) assigning one or more passages detected in a frame of image data to one or more previously-detected passages in a different frame of image data based on i) one or more edges of the one or more detected passages; ii) the one or more corners; and iii) the tracking one or more points between frames of image data for each of the one or more detected passages in the one or more frames of image data.

In a further embodiment, disclosed is a method wherein the detecting one or more passages in one or more frames of image data comprises computing semantic segmentation of any passages in the one or more frames of image data; and computing an approximate bounding box for each detected passage in the one or more frames of image data.

In a further embodiment, disclosed is a method wherein the detecting one or more passages in each frame of image data comprises performing semantic segmentation on each frame of image data to provide a bounding box for each passage in each frame of image data; and applying a regression output that detects passage edges in each bounding box.

In a further embodiment, disclosed is a method for real-time detection and tracking of potential passages in an environment, the method comprising a) computing semantic segmentation of one or more passages in one or more frames of image data; b) computing one or more bounding boxes for the one or more passages, wherein the boundary of each of the of the bounding boxes is computed based on edge detection and corner detection of the one or more passages; and c) tracking the one or more bounding boxes between two or more frames of image data.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a,’ ‘an,’ and ‘the’ include plural referents unless the context clearly dictates otherwise.

### BRIEF DESCRIPTION OF THE DRAWINGS

FIGS. 1A and 1B depict example architectures of a two-output convolutional neural network according to the present application.

FIG. 2 depicts a side-by-side comparison of an input image frame and a segmentation mask output of the neural network.

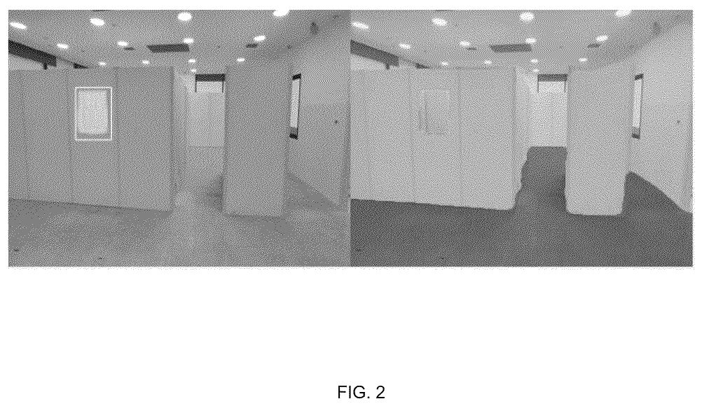

FIGS. 3A and 3B depict a side-by-side comparison of an input image frame and an edge detection output of the neural network.

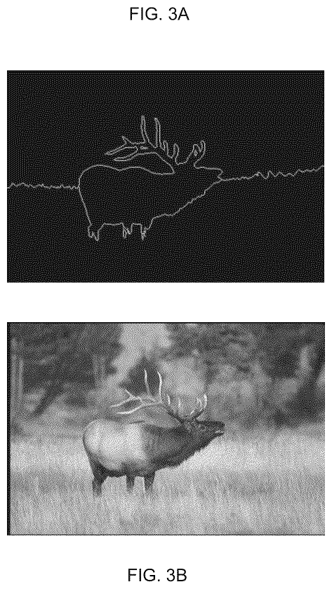

FIGS. 4A and 4B depict a side-by-side comparison of an input image frame and a passage detection output of the neural network.

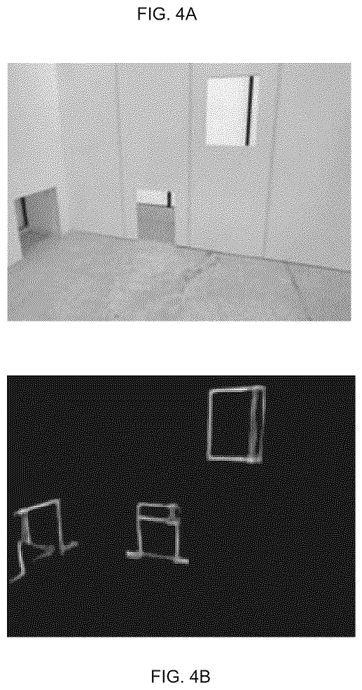

FIG. 5 depicts an example of a neural network schema according to the present application, including image input, convolution, rectified linear units (Relu), transposition, and crop outputs.

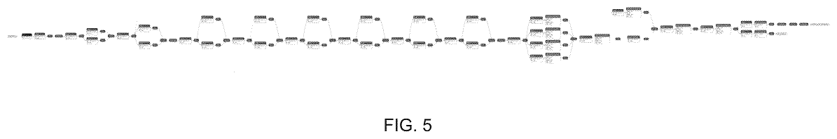

FIG. 6 depicts weighted intersection over union scores for bounding boxes from sequential image frames.

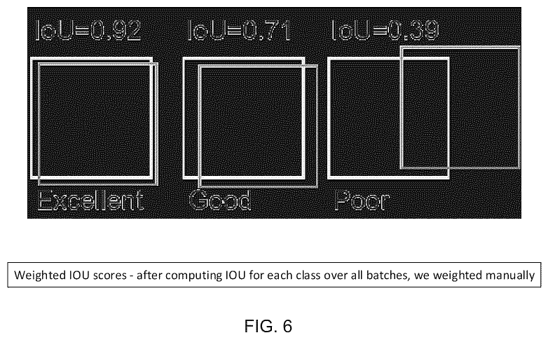

FIG. 7 depicts the equation used in the Dice coefficient for edge detection.

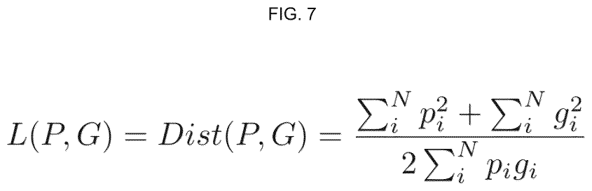

FIG. 8 depicts side-by-side post-processing images according to the instant application.

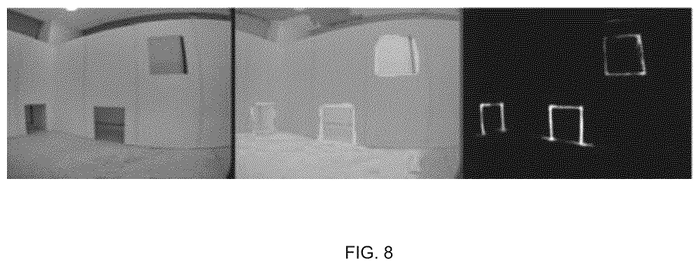

FIG. 9 depicts corner detection in an input image according to the instant application.

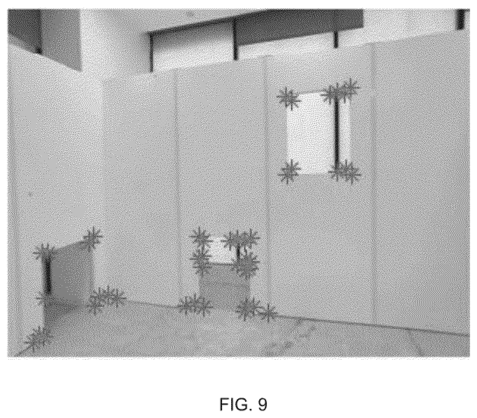

FIG. 10 depicts a passage detection and tracking algorithm flow according to the instant application.

FIG. 11 depicts edge and corner detection in an input image according to the instant application.

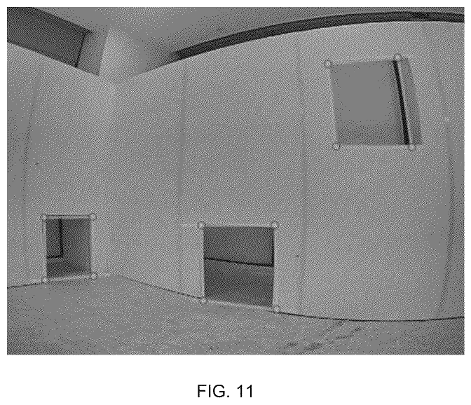

FIG. 12 depicts an example package diagram according to the instant application.

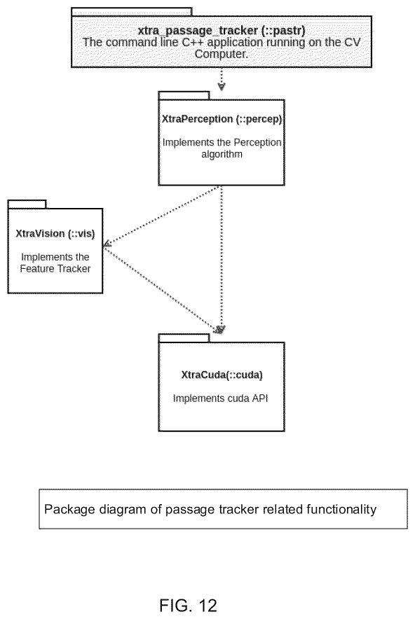

FIG. 13 depicts an example classes diagram according to the instant application.

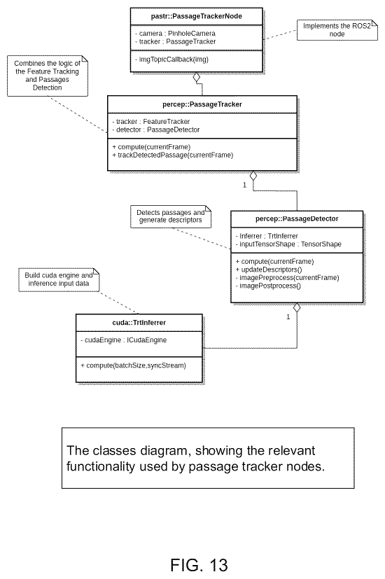

FIG. 14 depicts an example queues handler diagram according to the instant application.

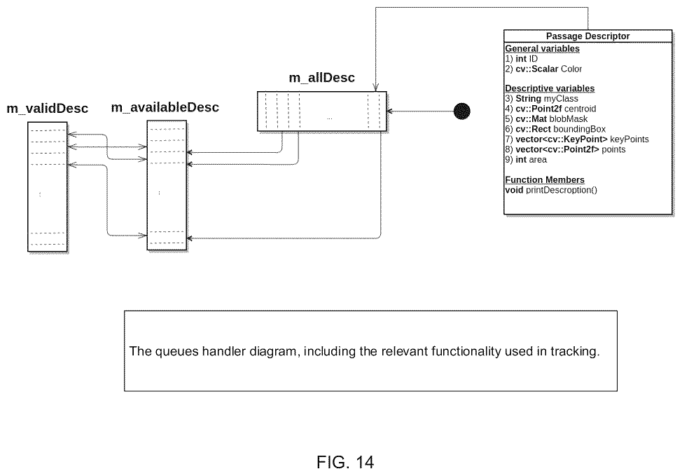

FIG. 15 depicts the information flow between the functional components. Note, the information flow between TAR and Path Planning is use-case specific and doesn't represent a real R&D dependency, hence the dotted lines.

FIG. 16 depicts UI elements indicate the orientation in the physical world, and being rendered in 3D provides a much more intuitive picture of reality.

FIG. 17 depicts an example of the tracked passages marked with 2D bounding boxes.

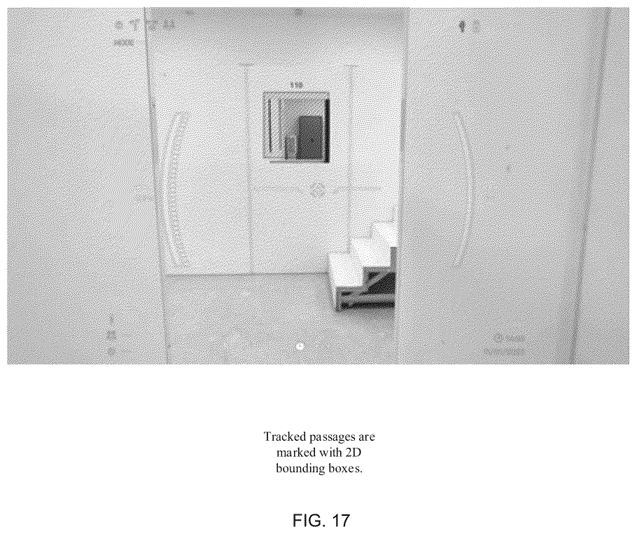

FIG. 18 depicts a screenshot from a VR demo showing a combination of stereo input video and various UI elements, as a virtual cockpit rendering.

FIG. 19 depicts an example of a hardware/software configuration for a system of the instant application.

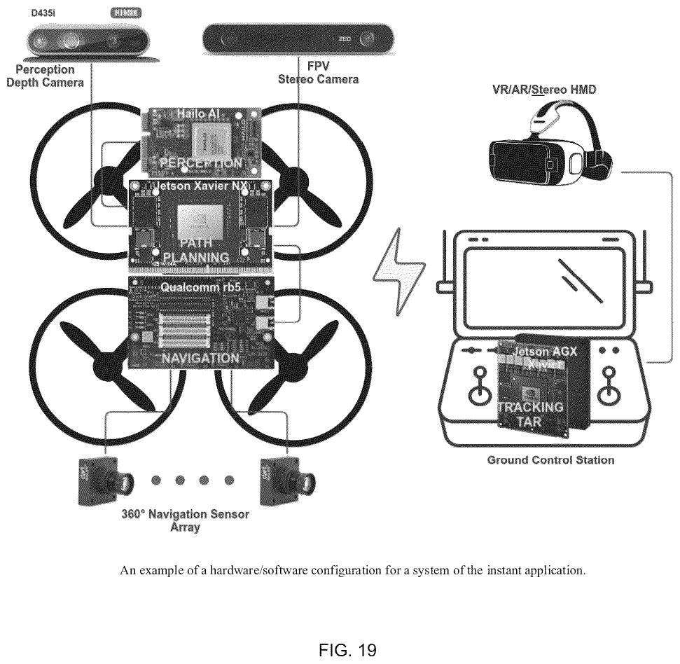

FIG. 20 depicts an example of aperture detection according to the instant application.

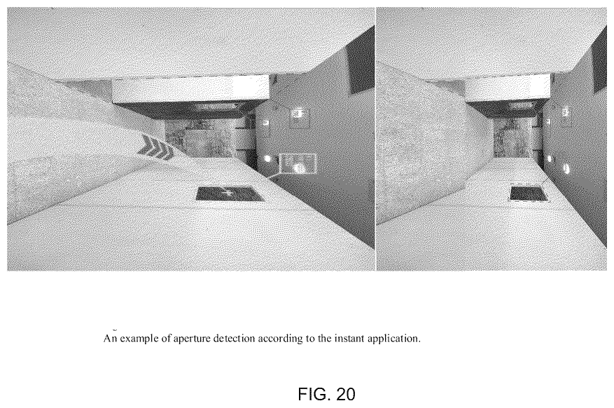

FIG. 21 depicts an example of person tracking according to the instant application.

FIG. 22 depicts an example of a drone approaching a passage in a direction orthogonal to the passage plane (to maximize clearance), changing velocity depending on proximity to it, and finally stopping after the passage is entered or passed.

FIG. 23 depicts Floor/Wall Reference with Current Height/Clearance, using a ray or arc pointer to mark a reference point, and extruding this point vertically from the floor or horizontally from the wall to an actual target point.

FIG. 24 depicts a system embodiment's constituent parts, where the particular features on the right will usually depend on features on the left on the same and previous rows.

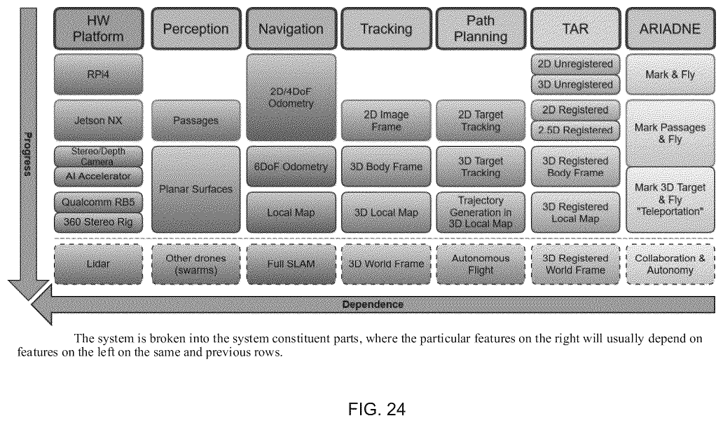

### DETAILED DESCRIPTION

### Background

As part of semi-autonomous outdoor/indoor navigation systems, a UAV operator typically sees video images of doors and windows of buildings within the environment of the UAV, or other openings or passages in the vicinity or the UAV. The present system detects, tracks, and gives the operator visual indications of potential openings or passages in the environment. In some embodiments, when a detected passage is selected by an operator, the system will autonomously navigate the drone to and/or through the selected opening or passage.

### Vocabulary

CNN: convolutional neural network.

Semantic segmentation: a type of CNN that receives an image as an input and returns an image of a pixel-level classification.

Regression: the regression layer computes the half-mean-squared-error loss for regression tasks in CNNs.

ONNX: an open neural network exchange, which is an intermediate representation of the model to easily go from one environment to another.

ResNet50: a convolutional neural network that is 50 layers deep with residual connections.

SqueezeNet: a convolutional neural network for computer vision that employs design strategies to reduce the number of parameters, notably with the use of file modules that compress or “squeeze” parameters using 1×1 convolution filters.

SGDM: stochastic gradient descent with momentum optimizer. This is an iterative method for optimizing an objective function with suitable smoothness properties in a way that minimizes oscillations.

Quantization: mapping input values from a large set (often a continuous set) to output values in a smaller set. This is used for acceleration in computation.

TensorRT: a library developed by NVIDIA for faster inference on NVIDIA graphics processing units (GPUs). It can give approximately 4 to 5 times faster inference in real-time.

Harris corner detector: is a corner detection operator used in computer vision algorithms to extract corners and infer features of an image.

Passage/opening/aperture: any opening in an outdoor or indoor environment that a drone or other mobile imager can pass through, e.g., doors, windows, skylights, archways, hatches, entrances to hallways, etc.

Loss function: a function that computes the distance between the current output of an algorithm and the expected output.

Cross entropy: a measure from the field of information theory, building upon entropy and generally calculating the difference between two probability distributions.

Focal cross-entropy: addresses class imbalance during training in tasks like object detection; also known as focal loss; a dynamically scaled cross-entropy loss.

### System Overview and Implementation Examples

In some embodiments, the system is capable of running on the Jetson Xavier NX platform in real-time at about 30 frames per second (FPS). As a non-functional requirement, the system may be implemented using a Compute Unified Device Architecture or CUDA. In some embodiments, the system may run in less than 50 ms on an image patch of 120×160 pixels.

### System Overview

### Passage Semantic Segmentation

In some embodiments, as a functional requirement, the system uses passage semantic segmentation to compute semantic segmentation of e.g., doors and windows, and computes an approximate bounding box for all detected passages.

### Passage Locator Function

In some embodiments, as a functional requirement, the system detects and tracks the bounding boxes of each detected passage. The system may be implemented as a robotic operating system 2 (ROS2) node and publish the computed bounding boxes to the network.

In some embodiments, as a non-functional requirement, the system may run at less than 30 ms per input frame.

### Passage Contour Detection Function

In some embodiments, as a functional requirement, the system may detect the exact passage boundaries.

### Algorithms

In some embodiments, the system may include two primary alternating steps: detection and tracking. The system can detect passages in every single frame and track them from one frame to another, for example, using intersection over union (IoU), DeepSORT, or optical flow-based methods as overlap metrics to assign a new passage detection to passage detections in previous frames until the target is reached or tracking is lost.

### Detection

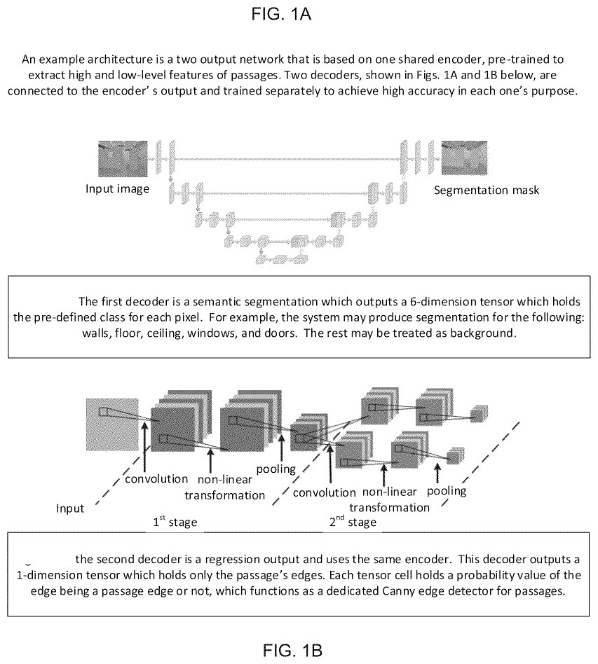

In some embodiments, detection is done using a U-net shaped CNN (see FIG. 1A) with two outputs, based on the SqueezeNet architecture. Input camera frames are processed through the first stage of the network called the encoder.

The encoder extracts high- and low-level features. The second stage of the network is called the decoder, which receives the processed input image from the encoder and detects or assigns the output as passages or not passages.

In some embodiments, the architecture is a two-output network that is based on one shared encoder, pre-trained to extract high- and low-level features of passages. Two decoders are connected to the encoder's output and trained separately to achieve high accuracy in each one's purpose.
1. In this example, the first decoder is a semantic segmentation which outputs a 6-Dimension Tensor which holds the pre-defined class for each pixel. For example, the system may produce segmentation for the following: walls, floor, ceiling, windows, and doors. The rest may be treated as background.
2. In this example, the second decoder is a regression output and uses the same encoder. This decoder outputs a 1-dimension tensor which holds only the passage's edges. Each tensor cell holds a probability value of being a passage edge or not, functioning as a dedicated Canny edge detector for passages.

### Tag, Train and Export the Network

Tagging, training, and network design may be done in MATLAB with the deep learning and image processing toolbox.

Tagging may be done in two steps. The first step is for classification purposes, and most of the data are open source indoor images with corresponding annotations.

See the following for examples of publicly available open source datasets:

http://groups.csail.mit.edu/vision/datasets/ADE20K/

http://host.robots.ox.ac.uk/pascal/VOC/voc2010/index.html

http://buildingparser.stanford.edu/dataset.html

https://www2.eecs.berkeley.edu/Research/Projects/CS/vision/grouping/resources.html

In addition, the system can be trained with annotated images such as those from videos of local houses, stock images, or videos tagged using classic computer vision algorithms in order to improve accuracy.

Tagging for Classification I: Low accuracy, fast results

In order to achieve high accuracy of passage detection in a test environment, computer vision algorithms for masking and tracking can be used to generate annotations for the training data.

### Overview of the Tagging Algorithm:

1. Choose a long sequence of frames from a video with as many visible passages as possible.
2. Generate a first binary mask of the visible passages to initialize tracking. There might be multiple blobs of passages in the frame.
3. For each passage blob, extract strong features using available MATLAB algorithms (in some cases, manual selection based on the number of features will achieve better tracking).
4. Using a MATLAB built-in tracker algorithm, we track each of the features corresponding to the each of the blobs, using a region-of-interest (ROI) mask as an argument.
5. In the adjacent frame we search for the best match for each feature, generating a new estimated bounding box for each group of features. This bounding box will be our new annotation.
6. In order to improve annotation accuracy, a local graph cut may be used to fill the passage area in a more accurate shape, and the results saved in a temporary binary mask.
7. The next operation is to load the pre-trained network with floor, ceiling, wall, and door classes to add tags to the rest of the pixels.
8. The next operation is to save the original image and the full annotated mask in a specified folder.

### Tagging for Classification II: High Accuracy

In order to achieve better precision and accuracy of detection on in-house testing environments, manually tagging of frames captured from a test video may be done. It is preferred that frames are carefully selected in order to cover as much as versatility in the data as possible, for example a wide range of features to be tagged, such as multiple different examples from the floor, ceiling, wall, window, and door classes. Tagging may be done with built-in MATLAB applications found in its computer-vision toolbox.

A second tagging stage is for edge detection. For this, one or more open source datasets from the internet may be used, such as “BSR_bsds500” [4], which holds about 500 images with its corresponding binary mask for only high-level edges.

### Tagging for Edges Regression I: Generate a Tagging Tool

A first iteration is to generate a tagging tool for better performance in a testing environment. For this, transfer learning may be used with a pre-trained deep network. This allows for the tagging and classification of new in-house data as desired.

### Tagging for Edges Regression II: High Accuracy

In this embodiment, a second iteration is based on the first iteration above, combining the classification result with a two-step tagging method. First, the desired image that we want to tag is processed in the edge detection network, resulting in good detection of high-level edges in all of the images. Second, because we want only passages' boundaries, the same input image may be pushed to the classification network, taking only the passages mask and using an AND operation to clear all other edge detection.

At this point we have a high accuracy, high-level “only boundaries” edge detection for passages.

### Training

Training is also done in MATLAB, and network design is based on a modified SqueezeNet architecture.

### Important Training Parameters:

1. Optimizer=stochastic gradient descent with momentum (sgdm).
2. Momentum=0.9.
3. Learn Rate Drop Factor=0.3.
4. Initial Learn Rate=1e-3.
5. Learn Rate Drop Period=80.
6. Number of Epochs=300.

### Loss Function

In order to improve accuracy and network efficiency, a custom loss function may be used to take into account the following metrics to maximize the result from input data. Because the network generates two different outputs, loss may be computed separately for each output.

### Loss for Segmentation

1. IOU: Intersection over union may be used as a loss function to “punish” the network on shape mismatches for detected objects.
2. Weighted IOU scores: after computing IOU for each class over all batches, importance of the detection quality may be weighted manually in one or more desired classes. This results in a high score or low loss for better results in passages masks over other classes.
3. Focal cross-entropy: this metric may be used to overcome the imbalance of differences between classes, resulting a better detection in small blobs. The network eventually will become more sensitive for small objects.

### Loss for Edge Detection

1. MSE: In this embodiment, the two outputs network was trained as one block. In this example, the loss function takes into account the performance of the edge detection. In some embodiments, simple mean squared error (MSE) loss may be used between the predicted and the true edges matrix.
2. MAE: Mean absolute error (MAE) may be calculated as the average of the absolute difference between the actual and predicted values.
3. Dice coefficient for edge detection [5]: Given an input image I and the ground-truth G, the activation map M is the input image I processed by a fully convolutional network F. The objective is to obtain a prediction P. Our loss function L is given by:

$$L ( P , G ) = Dist ( P , G ) = \frac{{\sum }_{i}^{N} {p}_{i}^{2} + {\sum }_{i}^{N} {g}_{i}^{2}}{2 {\sum }_{i}^{N} {p}_{i} {g}_{i}}$$

All losses are then checked for being in the same scale and weighted sums are computed with a strong bias to segmentation performance. Resulting loss values may then be fed into the network optimizer.

### Inference and Image Post-Processing

Image post-processing is an important step in extracting the detection and increasing the confidence in the accurate identification of detected passages.

In order to improve the confidence, we applied thresholding on each layer of the output image with a probability of 95% to be a member of the class. Then, taking each binary mask and applying dilation and Erode in the following order to improve detection. This method relies on the assumption that passages are located inside walls:
1. The passage's binary mask is dilated with a rectangle structure element, resulting in an increase in the size of each detected blob.
2. Invert the walls mask with bitwise-NOT, giving another mask with passages blobs in addition to walls, ceiling, and floors.
3. Apply Erode on the inverted walls mask to decrease the size of passages blobs.
4. Subtract from the inverted mask ceiling, floor, and background masks. This provides additional potential passages blobs.
5. Apply bitwise-AND between passages mask and the mask from above, which will keep only the overlap between both detections.

At this point we have higher confidence passages blobs; in the next step we generate a descriptor for each blob with a unique instance.

### Tracking by Detection

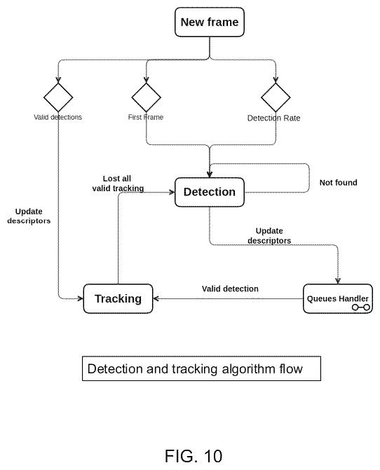

Tracking is based on the detection in every frame. We take the network outputs after the post-processing described above and generate descriptors for any new detections (see FIG. 10):
1. Loop over all existing descriptors and search for the highest IOU with each new detection.
2. If overlap between a new frame and a previous frame is not detected, then we create a new descriptor.
3. If overlap is detected between a new frame and a previous frame, we choose the highest IOU as the new detection and update relevant parameters.
4. For each new descriptor, we extract features using Harris corner detection, and save all key-points in the descriptor. Features are used only for deciding when to discard passages and delete descriptors. All features are tracked using optical flow techniques involving known methods such as phase correlation, block-based methods, differential methods, or discrete optimization methods.

The input image for the features detector is a patch from the full image that was cropped from the detection masks (e.g., output from the network). Then we combine the patch with the edges by multiplying them. The result of this multiplication is the passage edges only (after a dilation) from the original patch.

In this way we get only strong features to track that represent the best the shape of the passage and improved bounding box estimation in the next frame without detection.

### Extract Corners

Corner detection is important for estimating distance from drone to passage, and for estimating orientation of the passage relative to the drone; using the corners we can compute triangulation of the four corner points of each passage in stereo vision.

The algorithm outline:
1. Using the passages segmentation result, crop each passage's edges from the full edges probability map and store it in the corresponding descriptor.
2. For each passage's edges patch we estimate the four lines that represent the passage frame. In order to compute each line with high accuracy, we crop the patch into three patches, on horizontal and vertical axes. Under the assumption that the edges are closer to the outer frame of the patch, we take the crops closest to the outer frame sequentially.
3. Each crop from the passage patch is processed independently. To estimate and fit the best line, we normalize each crop, applying a threshold, and extract all non-zero value coordinates.
4. Using the least squares method we compute the regression line, given all the thresholded pixels from the previous step.
5. At this point we have a representation of the four sides of the passage frame. We then compute the intersection between the relevant lines.

### Integrated Implementation Environment

The following integrated implementation environment describes the use of opening detection methods and systems described above in the human operation of drones in the field. Numbers in brackets refer to reference links found at the end of this section.

### Vocabulary

Operator (User)—a person operating an unmanned vehicle, for example, an unmanned aerial vehicle (UAV), an unmanned submarine drone, an unmanned aquatic drone, a terrestrial unmanned vehicle or terrestrial robot, or a subterranean unmanned vehicle.

HMD—head mounted display, e.g., as may be found in virtual reality (VR), augmented reality (AR), or stereo display headsets.

Telerobotics—the area of robotics concerned with the control of semi-autonomous robots from a distance [1].

Teleoperation—indicates operation of a system or machine at a distance [2].

Telepresence—refers to a set of technologies which allow a person to feel as if they were present, to give the appearance of being present, or to have an effect, via telerobotics, at a place other than their true location [3].

Human Machine Interface (HMI)—means by which humans and computers communicate with each other. The human-machine interface includes the hardware and software that is used to translate user (i.e., human) input into commands and to present results to the user [4].

Odometry—the use of data from motion sensors to estimate change in position over time. It is used in robotics by some legged or wheeled robots to estimate their position relative to a starting location [6].

Localization—the process of determining where a mobile robot is located with respect to its environment. Unlike odometry, localization output is the robot position in some absolute “world” coordinate frame, e.g., GPS, a Cartesian coordinate system, or a map. Localization may rely on odometry.

Real-Time Path Planning—consists of motion planning methods that can adapt to real time changes in the environment. This includes everything from primitive algorithms that stop a robot when it approaches an obstacle to more complex algorithms that continuously take in information from the surroundings and create a plan to avoid obstacles, perform pathfinding, or take conditional actions [19].

Bounding Box (BB)—a rectangle surrounding an object, which specifies its position (center of the rectangle) and its rough size. A bounding box can be 2D or 3D, for 2D image objects or objects in 3D space respectively. Bounding box is a standard output for various tracking and object detection algorithms.

On-Screen-Display (OSD)—a graphical user interface (GUI) overlay rendered upon the FPV camera video, containing the all the relevant real-time information for the drone operator.

Visual Odometry—odometry using input from camera sensors.

Visual Inertial Odometry (VIO)—odometry using input from camera sensor(s), inertial sensor(s), and gyroscope(s).

6 DoF Odometry—the odometry which computes all 6 degrees of freedom of a rigid body pose in 3D space, i.e., 3 rotation angles (pitch, roll, yaw) and 3 position coordinates (X, Y, Z).

First-Person View (FPV)—also known as remote-person view (RPV), or simply video piloting, is a method used to control a radio-controlled vehicle from the driver or pilot's view point.

Tele-Augmented Reality (TAR)—similar to Augmented Reality [5], except it is from the drone's point of view using its FPV camera.

Robotics Perception (Perception)—geometric and semantic processing of the robot's surrounding environment, e.g., object detection and classification, depth estimation, semantic segmentation etc.; usually using machine/deep learning techniques [10].

Registration—the process by which AR applications can obtain a reference spatial framework within which to place virtual objects so that they match the expected location with respect to the corresponding real ones [18].

Simultaneous Localization And Mapping (SLAM)—the computational problem of constructing or updating a map of an unknown environment while simultaneously keeping track of an agent's location within it [20].

Micro-Tasks (MT)—the ARIADNE basic building block, micro-tasks include relatively simple tasks created by a user in real-time, for autonomous execution by a drone. ARIADNE teleoperation involves continuous execution of a series of MT's, created one after another by the user in real time.

Path Planner—the functional component responsible for path planning in the context of a given micro-task.

Line-Of-Sight/Non-Line-Of-Sight Tracking (LOS/NLOS)—line-of-sight tracking refers to optical tracking of an object or point, which must remain visible in the input video frames in order for the tracking to continue. Conversely, non-line-of-sight tracking supports cases when the object may be not visible during parts of the tracking process.

There are two widely implemented paradigms when it comes to drone teleoperation: manual (real-time control by a user of throttle and rotation angles, usually using control rods, e.g., joysticks) and autonomous (setting GPS way-points, a target to follow, etc.).

### 1.1.1. Manual Control

Pilots experience serious challenges for precise and safe drone operation when piloting with manual stick control. These challenges are especially notable in obstacle-saturated environments (e.g., indoors, in urban settings, in dense vegetation, etc.). Obstacle-saturated environments require relatively long and intensive training for pilots. Even with training, such teleoperations are still highly prone to human error. These factors limit teleoperation piloted missions to those flown by a relatively small number of pilots with the necessary skills within a given organization (often a designated specialist) and they are expensive (both in terms of training and in terms of having a relatively high rate of failure).

### 1.1.2. Autonomous Flight

Autonomous control, while much safer and easier for the operator, is severely limited in the number of its use cases. Building a fully autonomous system to operate in an arbitrary environment would represent a breakthrough in robotics due to the technological challenge of compensating for the infinite number of environment options the operating system would have to account for in flight. Even building artificial intelligence (AI) robotic systems, which are designed to autonomously operate in a reasonably well-defined domain, e.g., self-driving cars, has proved to be extremely difficult. Such specialized robotic systems have yet to be fully realized.

Therefore, while fully autonomous drones have a limited number of applications (e.g., security, inspection, delivery), the fully autonomous use cases are further limited by technological challenges, and in practice are confined to two main domains: 1) open air (e.g., GPS-assisted waypoint navigation); or 2) known indoor environments (such as pre-modeled or structured environments, e.g., warehouses and industrial facilities).

### 1.1.2. Conclusion

The confinement of virtually all the existing use-cases to these two narrow paradigms means that there is a huge gap in the domain of all potential drone use-cases, especially in the indoor environment. This present teleoperation system description, which we call ARIADNE, is our attempt to fill this gap.

### 1.2. The Vision

The present disclosure presents the teleoperation paradigms not as two separate mutually exclusive alternatives, but as two extremes on a continuous spectrum of operation. An objective of the present disclosure is to bridge the two extremes and create a real-time drone teleoperation paradigm. In some embodiments, this paradigm may be described as a combination of two fundamental HMI aspects: a highly immersive telepresence experience and extremely intuitive control via “task-and-fly” pilot-assisted operations. Both aspects are mutually dependent, working together to achieve a synergistic effect as further discussed below.

### 1.2.1. Immersive Telepresence

In order for an operator or pilot to make timely and informed decisions, a highly immersive telepresence experience must be implemented. The telepresence experience simultaneously maximizes the operator's situational awareness, while reducing the stress and effort associated with using a telepresence device (e.g., a screen, a VR headset, etc.). In some embodiments, it is a goal to maximize the operator experience of “being present” at the drone's location. Additional details are provided in the TAR section below.

### 1.2.2. Task-and-Fly

In some embodiments, an objective is to replace a task-and-fly operation, e.g., a task requiring intensive, continuous and error-prone pilot control, with discrete “micro-tasks” for an unmanned vehicle to accomplish autonomously. One non-limiting example of a task-and-fly operation is a mark-and-fly drone operation. Another non-limiting example is a fire-and-forget operation, applicable to drone-specific use cases. In each example, a series of micro-tasks or instructions, translate pilot intent into simple common mobility and action use-cases. Non-limiting examples of instructions include: a “go over there” instruction; an “approach this point/object” instruction; a “hover above this point/object” instruction; a “pick this object” instruction; a “place payload there” instruction; a “circle around this point/object” instruction; and a “follow this object” instruction.

In some embodiments an operator using a visual user interface, e.g., a virtual reality headset, may mark a location within a field of view with a handheld joystick, and select an object of interest. Based upon a known mission, the operator's intent may instruct an unmanned vehicle, like a drone, to perform a number of micro-tasks, such as proceeding to the selected object of interest. Other examples of micro-tasks include implementing a “go over there” to the identified object and “hover above the object” before implementing an instruction to “pick up the object.” In this example, the pilot may simply mark the object of interest, and a policy associated with the mission could automatically transmit to the drone the necessary micro-task instructions to pick up the object of interest. This system reduces the amount of click instructions an operator may be required to perform, making piloting easier. This improves the situational awareness of the pilot and reduces the tedium of sending detailed instructions, especially when latency concerns limit the timeliness or fidelity of received broadcasted instructions. See further discussion below in High-Latency Teleoperation.

In some embodiments, when the situation requires more nuanced control, which is not covered by the available micro-tasks, the operator may “switch to manual,” i.e., mark-and-fly operation mode. However, the goal is for sequential execution of micro-tasks to be sufficient for a performing continuous and smooth flight mission. The micro-tasks may be created using various inputs, including, e.g., joystick, mouse, or voice commands. In some embodiments, a pilot may elect to record the piloted motions or motion sequences for future use, or store the instructions for further refinement after the mission is complete.

### 1.2.3. High-Latency Teleoperation

A large challenge with long-distance real-time teleoperation is the high latency between control input and the visual-auditory feedback back from the remote robot. With high enough latency, any robotic system controlled via remote operation becomes unusable.

An objective of the present disclosure is to support teleoperation within the limitations of a reasonable latency (on the order of hundreds of milliseconds or even several seconds) in a relatively static environment since the micro-tasks are executed autonomously. The drone may then look up the ID, and cache the instructions for execution. In fact, in a perfectly static environment, an arbitrary latency can be tolerated in theory, through autonomous, programmed action that is responsive to environmental cues and remote sensor input.

In some embodiments, micro-tasks may be preloaded in a table of discrete tasks that can be modified by sensed environmental information. For example, a drone ten meters off the ground may implement an approach command, compensating for the drone's determined present distance from an optimum height for retrieval of the object. In one embodiment, an ID number for the micro-task may be associated with the operator's intent and transmitted to the drone.

### 1.3. Getting There

The present disclosure is broken into several functional-technological components:
Hardware Platform—integration of various computation and sensor modules.
Perception—semantic and geometric “understanding” of the surrounding environment. Using AI to find objects, geometric structures (e.g., buildings or planes) and to provide their semantics (the type of the object or structure).
Navigation—localization and mapping. Find the drone location in a frame of reference or a constructed/provided map of the environment.
Tracking—locating points/objects of interests in the specified frame of reference.
Path Planning—autonomous flight within the given task to the target point/object.
TAR—augmentation of the visual data received from the drone sensors with synthetic data relevant to its teleoperation, such as virtual symbols on a user's display to convey information to the user; target selection and task specification using the augmented visual data.
Algorithms—integration of all the above components into a concrete fully functional HMI use-case.

In some embodiments, the above components may be thought of as implemented in the order of implementation, and conversely in the reverse order of dependency—a component's implementation may depend on at least one preceding component. For example, all the other components may depend on the availability of the appropriate computing and sensing hardware; tracking is based on perception (e.g., the need to detect an object to be able to track the object) and more advanced features may depend on navigation (tracking an object in a reference frame may require knowledge of the drone's location in this frame).

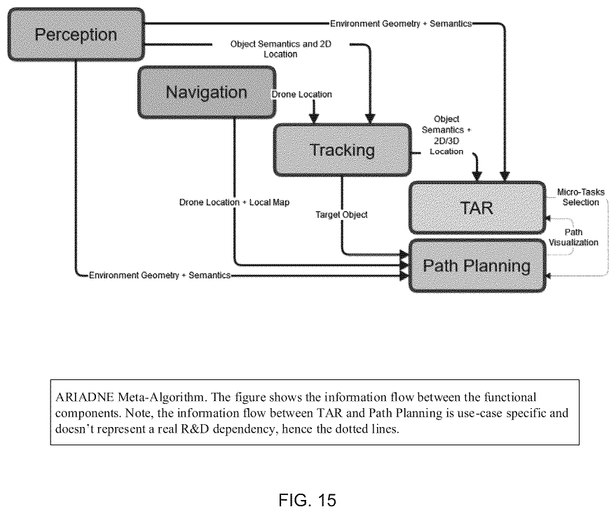

FIG. 15. illustrates the inter-component information flow, which illustrates one example of a dependency or conditional relationship between components.

The partition is conceptual, since each component is usually a set of loosely connected software components, which in practice may serve one or more purposes. For example, a 3D map of a drone's surrounding environment may be used for both Path Planning and Perception related functionality.

Each component has its respective roadmap, wherein a stage of a particular component will usually depend on completion of previous stages of this and possibly other preceding components. The components, their respective roadmaps, challenges, use-cases, possible technological solutions, inter-dependencies, etc. are further detailed below.

In some embodiments, the principles outlined in this disclosure support operations in an indoor environment, since these environments are particularly well suited to, and benefit from, augmenting an operator's intent with micro-tasks and predefined instructions.

### 2. Perception

Perception may include geometric and semantic processing of the robot's surrounding environment, e.g., object detection and classification, depth estimation, semantic segmentation etc.; usually using machine/deep learning techniques [10].

In some embodiments, a goal of Perception in the present context is for a robot to “understand” just enough about its environment, for the operator to create a new micro-task by relying on this understanding. An example is provided below.

Perception, Navigation, and Path Planning may all include a geometric understanding of the drone's surrounding environment for their own goals—micro-task creation, localization, and obstacle avoidance respectively. While it is possible for the same 3D information to be shared for various tasks, in practice the technological solutions will often be different, e.g., computing an occupancy grid for Path Planning; and computing a sparse point cloud for Navigation (SLAM).

### 2.1. Passages

In some embodiments, the term “passages” may refer to any rectangular opening within an indoor environment connecting separate building compartments, e.g., archways, doors, windows (of any kind), hallway entrances etc.

### 2.1.1. Purpose

Passages are some of the most challenging aspects of indoor navigation; they can be choke points in the robot configuration space (e.g., all possible robot positions in 3D space). In practice this means several things:
1. Accurate passage detection may improve the ability of drones to pass through, to navigate indoors.
2. They are relatively frequently navigated areas of space during indoor space exploration.
3. They are relatively well-defined objects.
4. Their relatively small size means a special challenge for manual (even mark-and-fly) control.

The combination of all the factors above means that automating navigation through passages is likely to simplify and improve indoor flight control.

### 2.1.2. Passage Detection 2D

Functionality:
Computes 2D bounding boxes in the input image.
Allows simple autonomous drone navigation to the passage via center tracking.
No 3D position and orientation of passage—no path planning.

Prerequisites are provided for illustrative purposes. While specific hardware is provided, a variety of hardware solutions may be used to realize the benefits of the feature implementation. For example, while a camera is disclosed, a LiDAR solution might similarly be used to record, construct, or map an environment. Similarly, while Jetson is a suitable mobile computing system capable of real-time deep learning processing, suitable alternatives may be selected to achieve processing speed requirements, battery life requirements, and weight requirements, as a few examples.
Can be implemented using only the monocular FPV camera.
Requires Jetson for object detection and tracking (using deep learning).

### 2.1.3. Passage Detection 3D

Functionality:
Computes a set of four 3D points—the passage corners.
Allows autonomous optimal 3D path planning to the passage.

Prerequisites:
A stereo camera.
Jetson.

### 2.2. Planar Surfaces

### 2.2.1. Purpose

An integral part of virtually all micro-task creation is a target designation. In some embodiments, an operator may want to mark for the drone either an arbitrary point in 3D space or a discrete object. Marking an arbitrary point in 3D space requires orienting/placing the virtual marker in relation to the visible indoor surfaces. Planar surfaces are of special importance for the following reasons:
1. Planar surfaces, such as walls, floors, and ceilings, dominate indoor geometry and are virtually always present in any field of view.
2. Even without a stereoscopic display, planar surfaces provide rich and intuitive visual cues about other objects' size and distance.
3. Can be used for identifying and designating potential landing spots.
4. Some planar surfaces may be used for orientation, for example floors are often used for path visualization.
5. Photogrammetry—3D reconstruction & mapping of the drone environment. Planar surfaces can potentially have an advantage over the regular Structure from Motion (SFM) methods, which are fragile, noisy, and computationally expensive. By approximating the environment with planes, we get a much less detailed representation of reality, but a much more robust, geometrically consistent, and visually clear sense of the space (as opposed to dense point clouds, for example) [22].

### 2.2.2. Method

In some embodiments, there are at least two broad methodologies to solve this challenge:

Using deep learning, e.g., [21]:
a) can be computed using a monocular camera
b) requires Jetson/AI accelerator for inference
c) potentially noisy/unreliable output; relative robustness w.r.t. untextured surfaces.

Classic methods using stereopsis, depth maps, or laser scans (see [22] for an example):
a) requires at least a stereo-camera; but also may require, depending on the algorithm used, a depth camera or LiDAR
b) relatively geometrically accurate output; poor handling of untextured surfaces, especially when relying purely on stereo

Both methodologies have their respective advantages and disadvantages. A chosen direction may also depend on respective TAR functionality—for example, if a target point designation only requires a floor (“teleportation”), which is typically a relatively textured surface, simple and cheap but effective stereo-related methods may be preferred.

### 2.3. Drones

Detect and track other drones for swarm related use-cases.

### 3. Navigation

In some embodiments, robotics navigation [23] can include self-localization, path planning, and mapping (for self-localization). In the present disclosure the navigation component will only include localization-related functionality and the path planning component will be discussed in a separate section below. In some embodiments, a goal of navigation may be to localize the robot in a coordinate frame or a map, where the map can be either predefined or constructed by the robot during its navigation (SLAM).

Odometry is the use of data from motion sensors to estimate change in position over time [6]. In some embodiments, a method to estimate the position of the drone relative to some starting position (e.g., the take-off point) is to integrate the drone's velocity constantly computed from the drone's sensors, i.e., IMU and cameras. Odometry is a basic building block of many localization algorithms.

### 3.1. 2D Odometry

### 3.1.1. An Example Purpose

In one embodiment, using a downward facing camera and IMU, drone odometry is computed in the horizontal plane. This is used to stabilize drone in flight (e.g., in a lateral axis during straight forward flight) and during position-hold (e.g., drone hovering in a determined position); it is also can be used for a rough estimation of flight path in 2D.

In the context of the present disclosure, 2D odometry can only support features which do not require full 6DoF position of the drone, e.g., simple line-of sight tracking features without obstacle avoidance or other path planning related functionality.

### 3.1.2. Hardware Prerequisites

2D odometry is a relatively computationally inexpensive functionality and can be implemented using Raspberry Pi 4 or similar hardware.

### 3.2. Full 6DoF Odometry

### 3.2.1. Purpose

6DoF (Degrees of Freedom) describes the full rigid body pose in 3D space—3 position coordinates+3 orientation angles. 6DoF odometry is the integral component of full robot localization functionality.

In the context of ARIADNE, 6DoF odometry allows more robust and sophisticated tracking of the points and objects. For example, non-line-of sight tracking of an object. That is, if an object's initial 3D position was provided out of the drone's tracking camera field of view, or disappeared from the field of view during the tracking, it would be possible for the drone to find the object by tracking the drone's own 3D pose relative to it. It also allows more complex path planning towards the target object, which does not require the target object to remain in the tracking camera's field of view.

### 3.2.2. Hardware Prerequisites

The current minimum computational power required for 6DoF odometry algorithms can be provided by either Jetson or RB5 [12] platforms. Jetson Xavier platforms are also providing their own software localization solutions [24] and are a good option to use.

There are several sensor configurations (monocular camera+IMU, stereo, stereo+IMU etc.), which can support a 6DoF odometry computation.

A minimum of a stereo camera with a good IMU is a realistic minimum for a robust solution.

### 3.3. Local Map Localization

### 3.3.1. Purpose

This involves construction of a map (usually an occupancy grid) of the drone's immediate surrounding environment in the receding horizon fashion, and computing the drone's 6DoF pose within this map. This is required for path planning (e.g., obstacle avoidance) during autonomous execution of the micro-tasks in a congested/obstacles-saturated environment.

### 3.3.2. HW Prerequisites

Same as for 6DoF odometry.

### 3.4. SLAM

### 3.4.1. Purpose

SLAM is useful for constructing or updating a map of an unknown environment while simultaneously keeping track of the drone's location within it [20]. In the context of the present system, accurate and robust SLAM will allow marking of an object location in a global frame of reference, allowing other agents (e.g., drones, people) sharing this map to navigate towards a marked object. Map sharing, it should be noted, is a non-trivial problem by itself, which is usually not solved in the context of a typical SLAM system.

Generally, SLAM is required for typical autonomous flight tasks, e.g. automatically returning to a take-off point.

### 3.4.2. HW Prerequisites

At a minimum, same as for 6DoF odometry. Possible implementations include distributed execution over several hardware components, e.g., a drone on-board computer and/or a ground station such as a Ground Control Station. A robust solution, capable of handling a wide range of challenging environments, often requires the use of LiDAR.

### 4. Tracking

For the purpose of this document, tracking is responsible for computing a given object's location in the specified frame of reference, e.g., in a 2D image reference frame, in a 3D drone's body frame, in an arbitrary 3D physical world frame, etc. Object location is required for TAR and path planning.

In the case of TAR, tracking output is computed, for example, in a stereo FPV camera reference frame. This allows TAR to render synthetic augmentation items (e.g., a virtual arrow pointing to the object), whose pose will be visually consistent with the tracked object.

In the case of path planning, tracking is responsible for providing the target objects' location in the context of the given micro-task. The path planner then will plan the drone trajectory to the tracked object. From an implementation point of view, in some cases the distinction between perception and tracking can be arbitrary—if a particular perception functionality includes object localization in the FPV camera coordinate system, then it de-facto provides tracking functionality. However, there are important technological and algorithmic differences between perception and tracking. For example, perception functionality is developed using AI techniques (primarily Deep Learning), while tracking mostly relies on classic computer vision methods (e.g., feature extraction and matching, stereopsis, Structure-From-Motion etc.). The features described below build upon perception, and therefore the basic prerequisites for them are the same as for the relevant perception functionality.

### 4.1. 2D Image Frame

The detected object is tracked in the input camera image 2D reference frame. This allows line-of-sight target tracking, which is relatively simple path planning towards the target object, such that it stays in the center of the tracking camera. This is often the simplest configuration, but it is somewhat limited in its usefulness. There is typically no estimation of distance to the object, its size and orientation (though possible in special cases with their own limitations), and it poses challenges for even simple path planning—e.g., the path planner doesn't know when to stop the drone.

### 4.2. 3D Body Frame

### 4.2.1. Overview

Here we track the object pose (position and orientation) in the drone body reference frame. Leaving aside for the moment the particulars of camera configuration and calibration, this allows us to know the position of the object in the FPV camera reference frame. This, in turn, allows for the rendering of virtual 3D augmentation items perceptually consistent with the 3D geometry of the scene. This functionality enhances the AR experience in any VR/Stereo display, where the scene is perceived in 3D by the user. It can also greatly assist in a regular 2D display (e.g., display screen or HMD), since even in 2D, correctly rendered 3D items will provide powerful visual cues regarding geometry, distance, and spatial relationships between objects. It also solves the problem of estimating the object distance and its orientation, which allows for more sophisticated path planning with optimal direction and speed estimations as the drone approaches the target.

### 4.2.2. Physical Points & Objects

Tracking arbitrary physical points (e.g., points on actual physical surfaces) and objects marked by a user can be useful for navigation and interaction (e.g., picking up objects). If the objects we wish to detect or pick up are of known predetermined types, this becomes a more tractable problem than that of passage detection.

### 4.2.3. Virtual Points

In yet another embodiment, the system may track a virtual (as opposed to physical) point in 3D space, i.e., a point in the air, which is not necessarily part of a physical object. This allows for fluid continuous navigation from point-to-point (sometimes referred to as VR “teleportation”), or just easy placement or sending of the drone to any point in space without manual control. This feature relies on planar surfaces detection, since a virtual point can only be defined by a user in relation to the visible surrounding environment. The point can be tracked either by tracking related physical points or via tracking the drone position (odometry/localization), or a combination thereof.

### 4.2.4. Prerequisites

Object detection perception functionality and related hardware.
Stereo/depth camera for stereopsis.
Planar detection for the virtual points.

### 4.3. Local Map

### 4.3.1. Purpose

Same as 3D Body Frame tracking, with an added benefit of the knowledge of the surrounding environment geometry. This knowledge allows no-line-of-sight tracking. Accordingly, since the target is being tracked in the local map reference frame, even when it disappears from the tracking camera field of view, the path planner will still be able to navigate the drone towards the target.

Moreover, in case of TAR, it will be possible to visually designate the target outside of the FPV image, e.g., in a virtual representation of the local map or by providing visual cues about the direction of the target outside of the field of vision (more about this in the TAR section below).

### 4.3.2. Prerequisites

Same as for the 3D Body Frame tracking, plus Local Map functionality for navigation.

### 4.4. 3D World Frame

### 4.4.1. Purpose

The World Frame is a more robust version of the Local Map with tracked targets going as far as the global map allows. This allows points of interest sharing between multiple drones and other multi-drone collaborative tasks.

### 4.4.2. Prerequisites

Same as for the 3D Body Frame tracking, plus full SLAM functionality for navigation.

### 5. Path Planning

### 5.1. 2D Target Tracking

### 5.1.1. Purpose

This is the simplest case, where the target is supplied as a 2D point (and/or the object bounding box) in the tracking/FPV camera image coordinates for every frame received from a camera(s). The path planner steers the drone such that the tracked object stays in the middle of the input image. This type of path planning is typically used for the simplest 2D case of passage tracking.

### 5.1.2. Limitations

In this method, there is no way to estimate the distance to the target, except in some special cases, under very strict assumptions, which can make it impractical in some situations. In the case of the passage tracking, it means the drone doesn't “know” when to stop. This happens when the passage is so close to the drone that the door or window frame used for tracking is not visible anymore, and therefore cannot be tracked.

### 5.2. 3D Target Tracking

### 5.2.1. Purpose

In this case, the target's 3D pose is provided in the drone's reference frame for every video frame received from the tracking stereo camera. Unlike in the 2D case, now the distance and the orientation of the target are known. So the path planner can steer the drone at optimal speed and direction relative to the target. For example, a passage can be approached from the orthogonal direction to maximize the clearance, and the drone will be able to slow down/stop at the appropriate distance from it. Partial or complete obstacle avoidance functionality can be achieved with planar surfaces detection as discussed in 2.2 above.

### 5.2.2. Limitations

In the absence of the knowledge of the surrounding geometry, full trajectory generation with obstacle avoidance is difficult if not impossible.

### 5.3. Trajectory Generation in a 3D Local Map

### 5.3.1. Purpose

Here the path planner has access to a 3D local map, including the 3D geometry of the drone's surrounding environment. The input to the path planner is the map itself and the target pose in the map's reference frame. This allows for optimal trajectory generation with obstacle avoidance.

### 5.3.2. Limitations

Local maps are usually constructed using occupancy grids or similar volumetric representations of the 3D geometry. The quality of the path planning in this case depends on the quality/robustness of the map, its completeness and resolution. A low resolution map, for example, can prevent a drone from flying through gaps, deeming them too narrow but which are wide enough in reality.

### 5.4. Fully Autonomous Flight

### 5.1.1. Purpose

Fully autonomous flight requires robust SLAM solutions. The functionality allows fully autonomous drone navigation from one arbitrary point to another in a global map of, e.g., a complex indoor environment (e.g., a multi-room building). This may be required for any use-cases involving target sharing.

### 5.1.2. Limitations

Technological challenges, high required hardware cost, and integration.

### 6. TAR

This section relates to video display and synthetic data visualization in the context of the present system. The term we use for this functionality is TAR—Tele-AR (Tele or Remote Augmented Reality). The basic idea behind TAR is to create a highly immersive experience of being present in a remote environment (telepresence)—via a drone and its sensors, with synthetic augmentation of the visual data from video streaming from the drone's cameras. The synthetic augmentation of the scene functions to facilitate the system-specific functionality and enhance the pilot's experience.

The terms synthetic and virtual are used mostly interchangeably; ‘synthetic’ is meant as a more general description for any visual artifact rendered onto the input video of the physical scene, and ‘virtual’ is meant to differentiate between an actual physical object and its synthetic representation.

Another key term extensively used in this section is registration, defined in the Vocabulary section as following:
the process by which AR applications can obtain a reference spatial framework in which to place virtual objects so that they match their expected location with respect to the corresponding real ones

In other words, registration is about rendering virtual/synthetic items onto the input video in such a way that their pose is consistent with the corresponding physical object's pose. For instance, a virtual text box annotating a physical object will appear to be connected to the physical object and placed at an appropriate distance from it; as the object moves, the box moves accordingly. Strictly speaking, an unregistered synthetic overlay normally would not be considered an AR functionality. Still, we start here by describing the unregistered cases, since they are first logical steps toward more complex “true” AR.

### 6.1. 2D Unregistered

This is the “regular” FPV drone OSD (On Screen Display). Here the 2D synthetic items are typically rendered at fixed positions in the FPV video.

### 6.2. 3D Unregistered

Here the input video is either stereo or mono displayed in a stereoscopic HMD (e.g., one separate optic channel per eye). The synthetic items are rendered in 3D; for example, each eye sees a synthetic item rendered at different angle and horizontal offset from the center of the image, thus creating a 3D appearance through stereopsis. Note that in case of the input video from a monocular FPV camera, the same video stream is shown in both optic channels, but the overall effect remains the same.

Even if the rendered item is geometrically two-dimensional, e.g., a text notification, it is still possible to create a 3D-like effect by rendering the text at different offsets in both optical channels—in this case the text will appear to be “hovering” between the user and the physical scene. Conversely, rendering items, whether 3D or 2D, without any offset onto an input stereo video will create a potentially confusing and even unpleasant effect, since the item will simultaneously appear at infinity and in front of physical objects.

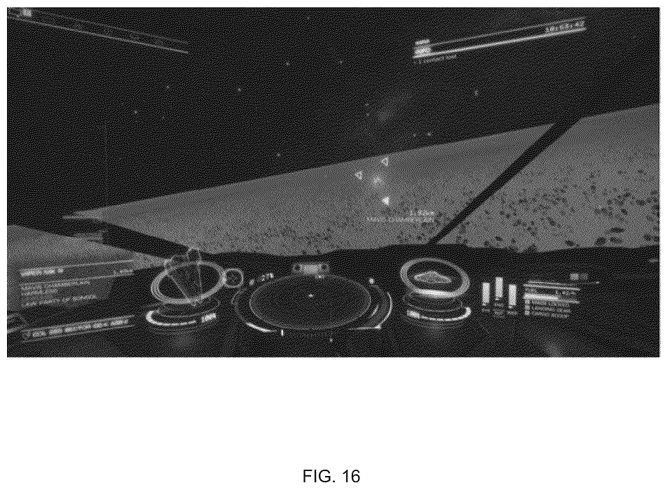

This functionality, while being technologically relatively simple, can provide a relatively large added value, by giving a user a much richer and more engaging visual experience. See FIG. 16 for an example of the kind of futuristic UI that it is possible to create. This can also be a very good test case for more advanced registered functionality.

While all items may be rendered in 3D, two particular UI elements will especially benefit from being rendered in 3D: the attitude indicator (gyro horizon) and compass. Those UI elements indicate the orientation in the physical world, and being rendered in 3D provides a much more intuitive picture of reality.

### 6.3. 2D

In some embodiments, the input is a video from monocular FPV camera. Synthetic items may be 2D elements, whose 2D size and position are aligned with the physical object. For example, the tracked passages are marked with 2D bounding boxes.

### 6.4. 3D Registered in Body Frame

In some embodiments, the body frame is the drone (body) frame of reference. For all intents and purposes the drone body frame and the FPV camera frame are basically the same.

In this case, the 3D position of a point of interest or full pose of a 3D object is computed in real-time. Technically, the displayed video can be mono or stereo—in both cases the virtual 3D object or other synthetic augmentation can be rendered in such a way as to appear visually aligned with the physical object. For example, augmentations may include a 3D rectangle rendered onto a tracked passage entrance, a trajectory computed towards the passage, and an annotation with passage ID and other information.

In some embodiments it is possible to create a synthetic stereoscopic registered overlay without explicitly computing 3D geometry of the augmented object. In this case, stereopsis (human 3D perception) of the synthetic overlay is achieved implicitly by rendering 2D registered synthetic items independently in each optical channel.

The main synthetic UI elements relevant to the system include the following:
1. Planar Surfaces Indicators—Indicates the planar surfaces for interaction.
2. Target Indicator—A tracked target point or object in the current micro-task.
3. Passage Indicator—Indicates the detected passages.
4. Pointers—Virtual rays/arcs for marking target points/objects.
5. Trajectory Indicators—Shows the virtual trajectory for the current micro-task.
6. Annotations—Textual information elements attached to physical or virtual objects.

### 6.5. 3D Registered in Local/Global Map

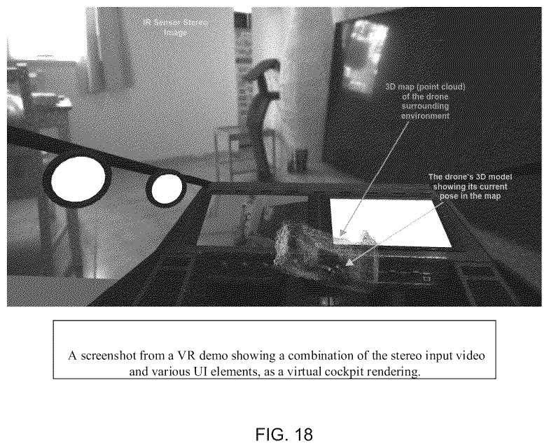

In some embodiments there may be access to a 3D map of drone's surrounding environment or a global map (e.g., obtained from SLAM). In such instances the target poses in the map's frame of reference are known. In addition to the body frame registered functionality, this allows the system to display the indicators of the targets (e.g., passages, points, or objects), which are not in the field of view or are obstructed by other physical objects. This can be done in two basic ways:
1. Display the synthetic indicator elements in the field of view, such that they point in the correct direction to the corresponding physical target, which is not visible at the moment.
2. Display the local map as another UI element with the target indicator inside the map. See FIG. 18 for an example of what this might look like. Note: in this image the drone itself is shown in the map, but this could be any other tracked target.

### 6.5. VR vs Stereo HMD for TAR

In both of these cases, video from the drone's FPV stereo-camera is used to observe physical reality, with the addition of a synthetic overlay of registered and unregistered elements. The crucial difference between VR and a stereo HMD is head tracking.

Head tracking allows head movement in a kind of virtual cockpit, which may be defined by various UI elements, one of which is the actual video from the drone's FPV stereo-camera. FIG. 18 shows a screenshot from such a VR demo [25] (note that in FIG. 18 the head is slightly turned to the left in the screenshot). The benefit of this approach is the ability to add various UI elements outside of the input video, thus effectively enlarging the visual space. A potential disadvantage is a less immersive experience—by disassociating the gaze direction from the actual drone's direction.

Another possibility is synchronizing user head movements with FPV camera orientation, or using a panoramic video.

### 7.0 Hardware

The system related hardware can be partitioned into the following categories:
A general purpose embedded platform, e.g., Raspberry Pi and Jetson—for computer vision, state estimation, image processing, odometry, mapping, graphics (GUI, AR), etc.
Dedicated AI processors, e.g., Coral [7] and Hailo [8]—for perception-related neural network inference, e.g., object detection
Camera and LiDAR sensors—for FPV, odometry, mapping, perception
Displays—e.g., screen, AR/VR/stereo HMD's—for TAR

The hardware components may either be used in the ground control station (GCS) or on the drone itself (ground vs. airborne). While in principle some components can be implemented either on the ground or airborne hardware (e.g., object detection can be computed on an airborne or ground computer), in some preferred embodiments the function assignments are as follows:
Drone functions: Navigation, Perception, Path Planning.
Ground functions: Tracking, TAR.

### 7.1 Raspberry Pi 4 (Drone)

Purpose

In an example embodiment, an onboard computer may be used for optical flow-based 2D odometry computations.

Limitations

This hardware is limited to two cameras, and is accordingly unlikely to run anything more performance demanding than a single instance of 2D odometry. It may not be suitable for anything requiring real-time stereo or deep learning.

### 7.2 Jetson Xavier NX (Drone)

### 7.2.1 Purpose

Allows real-time image processing necessary for real-time stereo computing, 6 DoF odometry and real-time neural net computation for perception functionality.

### 7.2.2 Limitations

Depending on the algorithm used, every component assigned to the Drone computer (e.g., Perception, Navigation, or Path Planning) may use all available computation resources.
Stereo/Depth Camera
FPV human 3D perception of the scene and UI elements.
A bare minimum for 6 DoF visual odometry (there are visual-inertial odometry (VIO) methods which allow one to compute 6 DoF odometry from combining IMU and a monocular camera, but these are less robust and are much harder for integration and calibration).
Points/objects 3D position computation in the drone reference frame; necessary for 3D mapping, path planning, tracking, etc. Perception vs FPV camera—same/separate.

### 7.4 Dedicated AI Processor

### 7.4.1 Purpose

Hardware is specifically designed to run neural net computations at relatively high frame rates and with relatively low power consumption.
Allows one to offload these tasks from Jetson (or other drone or ground computers). For instance, a Hailo AI Processor [8] allows one to run most, if not all, of perception functionality, thus freeing onboard Jetson for Navigation.

### 7.4.2 Limitations

Possible compatibility issues between various AI accelerators and embedded platforms (Jetson).

Neural nets may have to be modified/adapted to run on an accelerator (partial support compared to Jetson).

### 7.5 360° Navigation Sensor Array

### 7.5.1 Purpose

To provide spherical (full or partial) camera coverage of the drone's surrounding environment. Necessary for construction of a local 3D map of the drone's surrounding environment for any frame.
Allows obstacle avoidance in any direction of the drone's movement—as opposed to just the forward flight direction with one stereo sensor (although it is possible to construct a 3D map from one forward stereo sensor, this is much more algorithmically and computationally challenging, and less robust.).

### 7.5.2 Limitations

Requires extremely challenging mechatronics development and integration, e.g., custom electronic components. Requires special hardware supporting simultaneous multiple video stream processing.
Relatively complicated calibration process—during development, production, and possibly by the user customer. It also may require usage of a specialized platform (e.g. RB5 [12]).

### 7.6 LiDAR

Purpose
High accuracy 3D scanning of the drone's surrounding environment.

This is the primary sensor for full robust SLAM functionality (see and [14] for examples).

Limitations
Weight, cost, and energy consumption.

### 8.0 Teleoperation Method and Use-Cases

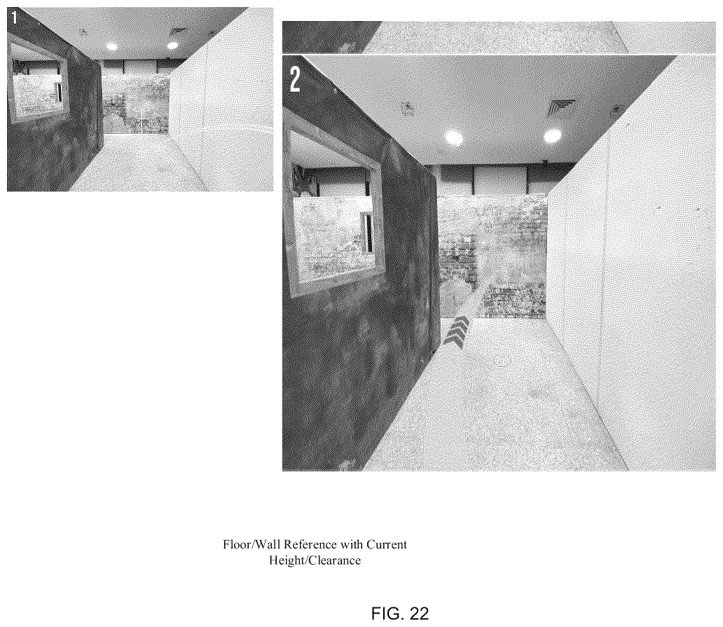

This section assembles functional-technological components into use-cases. As in previous sections, these use-cases are listed in the order of their logical progression and represent non-limiting examples of how the system works and how it may be configured. In some embodiments, the prerequisites are summarized in FIG. 22.

### 8.1 Mark & Fly

Mark & Fly functionality represents a first logical step towards the system vision—the first step beyond fully manual stick control and towards fully autonomous micro-task instruction execution.

A possible extension of this feature, which would make it fit within the scope of the system vision, is automatic linear path planning towards an arbitrary point marked and tracked in 2D.

### 8.2 Mark Passage & Fly

As explained above, passages represent a case of special interest both because of their significance and the difficulty that they present for indoor flight. The basic idea is for a drone to automatically detect and track all the passages in its field of view. Then the user may select a target passage and the drone will autonomously pass through it.

### 8.2.1 2D Case

Passage detection and tracking can be accomplished with one or more 2D input images from a 2D FPV camera. In one embodiment, the TAR experience is simply designating the target passage using rectangle overlays in the FPV video.

A limitation of 2D tracking is an inability for the path planner to detect the size, orientation and, most crucially, the distance of the target passage. Which means that the path planner has a hard time computing optimal direction and speed of approach to the target passage, giving only a rough estimate of both distance and orientation.

### 8.2.2—3D Case

The passage is tracked in the stereo camera, so the full 3D geometry of the passage (distance, size, and orientation) is known.

This allows rendering of a 2.5D/3D virtual overlay in stereo/VR HMD such that it will be correctly registered to the physical passage, giving a virtual 3D item representing the target passage (an arrow pointing to it, the passage frame, and/or an annotation of the classification of the passage, e.g., window, door, etc.). This will appear to the user appropriately embedded in the physical scene.

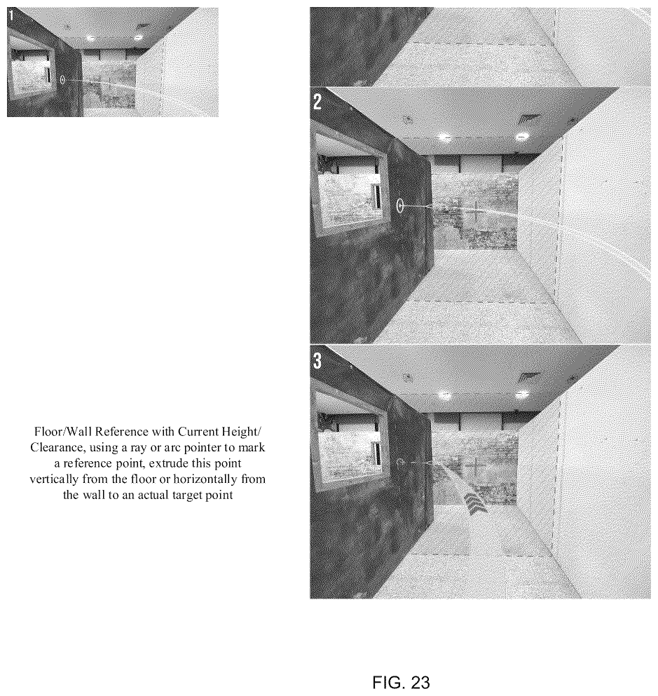

The path planner will be able to plan the flight trajectory in an optimal way—for example, the drone will approach the passage in a direction orthogonal to the passage plane (to maximize clearance), change velocity depending on proximity to it, and finally stop after the passage is entered or passed. See FIG. 23 for an example.

### 8.3 Mark 3D Target & Fly

### 8.3.1 Physical Target

By physical target we mean a point on a surface or an object—as opposed to a virtual target, which can be an arbitrary point in 3D space around the drone. Whether we mark and use an arbitrary point or an actual point or object depends on a specific micro-task (see below), where the objects will usually belong to predefined sets of classes, e.g., wall points, passages, people, guns, etc.

The point is selected using a remote control—for example, in a fashion similar to the Oculus VR virtual laser pointer. TAR provides virtual augmentation of the selected point or object—tracking the marker and relevant annotation.

Examples of corresponding micro-tasks: Approach

In this embodiment, the drone flies towards a specified target and hovers in front of it or above it. The choice of the hovering position relative to the target may depend on its relative position (e.g., level with it on a horizontal plane; above it; below it; or in front of it), particular drone configuration (FPV camera placement on the drone and its degrees of freedom), or specified by the pilot through the UI.

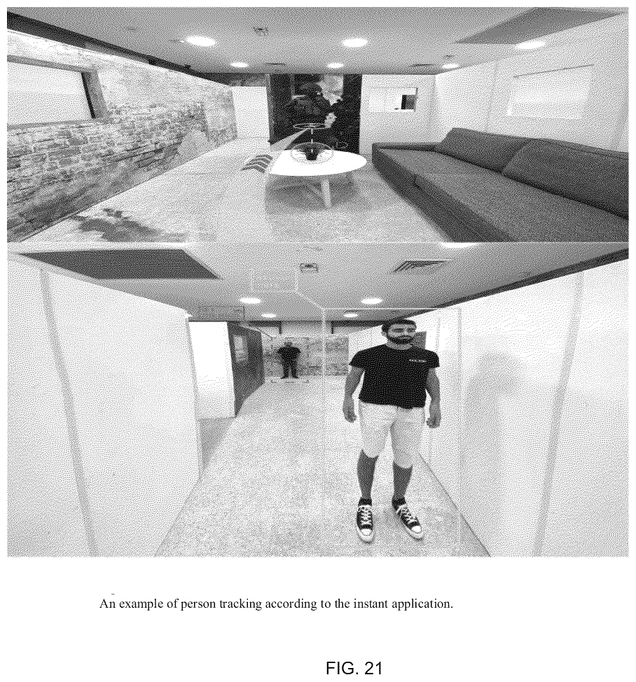

Follow (an object)—The drone follows the target object—e.g., a person (FIG. 21).
Scan (a point or an object)
The drone approaches the designated target and flies around it in a predefined trajectory, while keeping it in focus. Pick up (an object): The drone approaches the designated target and a) automatically picks it up (this can be technologically challenging depending on object and retrieval mechanism used by the drone), or b) is manually operated to complete the task (which is a special case of the Approach micro-task).

### 8.3.2 Virtual Target

As mentioned above, a virtual target can be any point in the visible 3D space around the drone. We envision the micro-tasks using a virtual target to be the core of the ARIADNE functionality, since they allow free navigation in indoor environments and can almost completely replace full manual control.

One advantage of marking a virtual target is the ability to use the surrounding 3D geometry as a reference, relative to which the virtual target is defined. In some embodiments, the focus may be on using planar surfaces for reasons explained above in section 2.2.1, the most important of which is the fact that planar surfaces (especially walls and floors) provide powerful visual cues for scene objects' size and their relative distances. Thus, using an arbitrary nondescript point on a wall or floor as a reference to a virtual target near it gives a user an intuitive grasp of the target position.

In some embodiments, only the Approach micro-task is relevant for the virtual target. TAR can visualize the synthetic artifacts for marked reference points, the arc/ray pointer used to mark the point and the reference axes connecting virtual points to the reference points, etc.

In some embodiments, one or more of the following may be used for marking a virtual point:
Floor/Wall Reference with Current Height/Clearance (FIG. 22)
In this case we use an arc pointer to mark a reference point. The virtual target is created at the drone's current height/clearance. Floor/Wall Reference with Specified Height/Clearance (FIG. 22)

Use ray or arc pointer to mark a reference point, extrude this point vertically from the floor or horizontally from the wall to an actual target point.

### 8.4 Collaboration & Autonomy

Collaboration & Autonomy may refer to fully autonomous tasks and multi-drone collaboration. These two functionalities may have a large overlap between them and the core functionality required for their implementation in any non-trivial indoor environment (e.g., multiple rooms) is full SLAM and global map path planning.

Collaborative tasks are based on, or can be built from, the previously mentioned micro-tasks. Only this time, a micro-task can be executed by one drone using a target marked by another drone. The basic micro-task flow might be accomplished as follows:
1. Drone A marks a target (virtual or physical).
2. Drone A shares the target description (position, visual signature, type, etc.) in the global map's reference frame.
3. Drone B autonomously navigates to the target and executes a specified micro-task.

Strictly speaking, autonomous path planning and navigation are not required for this—a user can navigate “manually” (using micro-tasks) to the marked object using the visualized global map for reference.

### 8.5 Putting It All Together

### 8.5.1 3D Display in ARIADNE's Context

All the use-cases above do not inherently necessitate usage of the 3D displays—all the 3D UI elements can be rendered on 2D displays just as well. However, we do strongly believe that in order to achieve synergistic effects, as we mentioned earlier in the introduction section, a 3D HMD is important for realizing the full benefits of the system.

Human visual perception is fundamentally three dimensional, although it is limited to relatively short distances of several meters. To effectively designate the micro-task targets, especially the virtual ones, we need a very good intuitive grasp of 3D geometry around the drone. And the best way to achieve this is using human stereopsis, e.g., via stereoscopic video displays.

### 8.5.2 Control Flow

In some embodiments, a goal is to create a fluid control experience, where micro-tasks are seamlessly concatenated into one continuous flight.

For example, such a flight could look something like this:
mark a window and fly through it;
orient and rotate to a direction for exploration;
mark an object on a table and approach the object from above;
mark a door and fly through it;
orient and rotate to a direction for exploration;
mark a virtual target and fly to it; while flying, find objects of interest or new directions for exploration.

Note: the “manual” rotation of the drone upon completion of a micro-task could be part of the micro-task.

The diagram below summarizes the system outlined thus far.

In some embodiments, hands-free operation will allow a drone to follow the operator.

In some embodiments, a drone may be controlled by voice commands. In some embodiments, a drone may be controlled using a weapon attachment.

In some embodiments, a Google-Glass type of display may be used; in other embodiments, a full AR display may be used, e.g., a drone FPV/mapping aligned to an AR HMD.

### 9.2 AR

In some embodiments, a drone may stream a real-time 3D depth-map registered to an operator's AR HMD, allowing the drone operator to “look through walls” from outside of a room or building.

### 9.3 Panoramic FPV

In some embodiments, an FPV sensor array may be used for a panoramic view. For example, a panoramic display in a VR HMD using stitched seamless panoramic image controlling gaze direction with head movement streaming selectively the relevant part of panorama. Alternatively, a display in a special panoramic head set (similar to a 4-focal panoramic night vision goggles) may be used, e.g., using 4 displays/lenses receiving video streams from respective 4 FPV cameras. In one embodiment, two peripheral videos are possible with reduced resolution.

### REFERENCES

1. https://en.wikipedia.org/wiki/Telerobotics
2. https://en.wikipedia.org/wiki/Teleoperation
3. https://en.wikipedia.org/wiki/Telepresence
4. https://www.britannica.com/technology/human-machine-interface
5. https://en.wikipedia.org/wiki/Augmented_reality
6. https://en.wikipedia.org/wiki/Odometry
7. https://coral.ai/
8. https://hailo.ai/
9. https://en.wikipedia.org/wiki/First-person_view_(radio_control)
10. https://www.esa.int/Enabling_Support/Space_Engineering_Technology/Automation_and_Robotics/Robotics_Perception
11. https://en.wikipedia.org/wiki/Simultaneous_localization_and_mapping
12. https://www.qualcomm.com/products/robotics-rb5-platform
13. https://www.livoxtech.com/mid-70
14. https://ouster.com/products/scanning-lidar/os0-sensor/
15. https://www.microsoft.com/en-us/hololens
16. https://www.oculus.com/quest-2/
17. https://www.fatshark.com/product-category/headsets/
18. https://www.igi-global.com/dictionary/3d-registration/65429
19. https://en.wikipedia.org/wiki/Real-time_path_planning
20. https://en.wikipedia.org/wiki/Simultaneous_localization_and_mapping
21. https://www.youtube.com/watch?v=d9XfMvVXGwM
22. Stamos, Ioannis & Yu, Gene & Wolberg, George & Zokai, Siavash. (2006). 3D Modeling Using Planar Segments and Mesh Elements. 3DPVT 2006.
23. https://en.wikipedia.org/wiki/Robot_navigation
24. Isaac ROS Visual Odometry
25. Unity-ROS Interoperability Study

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having ordinary skill in the art will recognize that the state of the art has progressed to the point where there is little distinction left between hardware, software, and/or firmware implementations of aspects of systems; the use of hardware, software, and/or firmware is generally a design choice representing cost vs. efficiency tradeoffs (but not always, in that in certain contexts the choice between hardware and software can become significant). Those having ordinary skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

In some implementations described herein, logic and similar implementations may include software or other control structures suitable to operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise controlling special-purpose components. Specifications or other implementations may be transmitted by one or more instances of tangible or transitory transmission media as described herein, optionally by packet transmission or otherwise by passing through distributed media at various times.

Alternatively or additionally, implementations may include executing a special-purpose instruction sequence or otherwise operating circuitry for enabling, triggering, coordinating, requesting, or otherwise causing one or more occurrences of any functional operations described above. In some variants, operational or other logical descriptions herein may be expressed directly as source code and compiled or otherwise expressed as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar modes of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those having ordinary skill in the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a USB drive, a solid state memory device, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read-only, etc.)), and/or electrical circuitry forming a communications device (e.g., a modem, communications switch, optical-electrical equipment, etc.). Those having ordinary skill in the art will recognize that the subject matter described herein may be implemented in an analog or digital fashion or some combination thereof.

Those skilled in the art will recognize that at least a portion of the devices and/or processes described herein can be integrated into a data processing system. Those having ordinary skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

In certain cases, use of a system or method as disclosed and claimed herein may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory.

Further, implementation of at least part of a system for performing a method in one territory does not preclude use of the system in another territory.

Any U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., operations), devices, objects, and the discussion accompanying them are used as examples for the sake of conceptual clarity and that various configuration modifications are contemplated. Consequently, as used herein, the specific examples set forth and the accompanying discussion are intended to be representative of their more general classes. In general, use of any specific example is intended to be representative of its class, and the non-inclusion of specific components (e.g., operations), devices, and objects should not be taken to be limiting.

With respect to the use of substantially any plural and/or singular terms herein, those having ordinary skill in the art can translate from the plural to the singular or from the singular to the plural as is appropriate to the context or application. The various singular/plural permutations are not expressly set forth herein for sake of clarity.

The herein described subject matter sometimes illustrates different components contained within, or connected with, different other components. It is to be understood that such depicted architectures are presented merely as examples, and that in fact many other architectures may be implemented which achieve the same functionality. In a conceptual sense, any arrangement of components to achieve the same functionality is effectively “associated” such that the desired functionality is achieved. Therefore, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of “operably couplable” include but are not limited to physically mateable or physically interacting components, wirelessly interactable components, wirelessly interacting components, logically interacting components, or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such a recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having ordinary skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having ordinary skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented as sequences of operations, it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method for real-time detection and tracking of potential passages in an environment, the method comprising:
a) detecting one or more passages in one or more frames of image data;
b) extracting one or more corners for each of the one or more detected passages;
c) tracking one or more points between frames of image data for each of the one or more detected passages in one or more frames of image data; and
d) assigning one or more passages detected in a frame of image data to one or more previously-detected passages in a different frame of image data based on i) one or more edges of the one or more detected passages; ii) the one or more corners; and iii) the tracking one or more points between frames of image data for each of the one or more detected passages in the one or more frames of image data.

2. The method of claim 1, wherein the detecting one or more passages in one or more frames of image data comprises:
computing semantic segmentation of any passages in the one or more frames of image data; and
computing an approximate bounding box for each detected passage in the one or more frames of image data.

3. The method of claim 1, wherein the detecting one or more passages in each frame of image data comprises:
performing semantic segmentation on each frame of image data to provide a bounding box for each passage in each frame of image data; and
applying a regression output that detects passage edges in each bounding box.

4. The method of claim 1, wherein the detecting one or more passages in each frame of image data is carried out using at least one U-net convolutional neural network.

5. The method of claim 1, wherein the detecting one or more passages in each frame of image data comprises:
receiving at least one input frame of image data;
processing the at least one input frame of image data with an encoder to extract high- and low-level features of passages as encoder output;
processing the encoder output with a first decoder for semantic segmentation; and
processing the encoder output with a second decoder with a regression output.

6. The method of claim 5, wherein the processing the encoder output with a first decoder for semantic segmentation comprises:
performing semantic segmentation to give a six-dimensional tensor, which holds a pre-defined class for each pixel.

7. The method of claim 5, wherein the processing the encoder output with a first decoder for semantic segmentation comprises:
producing segmentation only for classes including walls, floors, ceilings, window, and doors; wherein all pixels not in the above classes are treated as background.

8. The method of claim 5, wherein the processing the encoder output with a first decoder for semantic segmentation comprises:
using intersection over union as a loss function for shape mismatches in detected objects.

9. The method of claim 5, wherein the processing the encoder output with a first decoder for semantic segmentation comprises:
using focal loss on the encoder output to overcome imbalance in differences between classes and to better detect small blobs.

10. The method of claim 5, wherein the processing the encoder output with a second decoder with a regression output comprises:
producing a one-dimensional tensor that holds only the edges of any detected passages.

11. The method of claim 10, wherein each tensor cell of the one-dimensional tensor holds a probability value of being a passage or not.

12. The method of claim 3, wherein the applying a regression output that detects passage edges in each bounding box comprises:
applying at least one of mean squared error, mean absolute error, or Dice coefficient for edge detection as the loss function for edge detection.

13. The method of claim 12, wherein the Dice coefficient comprises a loss function L according to the equation
$$L ( P , G ) = Dist ( P , G ) = \frac{{\sum }_{i}^{N} {p}_{i}^{2} + {\sum }_{i}^{N} {g}_{i}^{2}}{2 {\sum }_{i}^{N} {p}_{i} {g}_{i}}$$
wherein P is a prediction; I is an input image; and G is the ground truth.

14. The method of claim 1, wherein the detecting one or more passages in one or more frames of image data further comprises:
applying a threshold to each layer of the output image with a probability of 95% of being a member of a semantic class.

15. The method of claim 1, wherein the extracting one or more corners for each of the one or more detected passages comprises:
a) estimating the characteristics of four lines that represent the boundaries of each detected passage patch;
b) crop each detected passage patch into three patches on horizontal and vertical axes;
c) normalize each crop by applying a threshold and extracting all non-zero value coordinates in each of the three patches to give thresholded pixels;
d) compute the regression line for each of the four lines using the least squares method applied to the thresholded pixels; and
e) compute the intersection of the four lines to give the corners.

16. The method of claim 1, wherein the tracking one or more points between frames of image data for each of the one or more detected passages in one or more frames of image data comprises:
applying at least one of intersection over union, optical flow, appearance descriptor, or the DeepSort algorithm to the one or more detected passages.

17. The method of claim 16, wherein the tracking one or more points between frames of image data for each of the one or more detected passages in one or more frames of image data comprises:
a) looping over existing passage descriptors to find the highest intersection over union (IoU) with each new passage detection;
b) if there is no overlap between a new frame and a previous frame, then creating a new descriptor for the detected passage;
c) if there is overlap between a new frame and a previous frame, then choosing the highest IoU as a new passage detection;
d) extracting features of each new passage descriptor using Harris corner detection; and
e) tracking the features between frames using optical flow.

18. The method of claim 17 wherein the input image for extracting features of each new passage descriptor comprises a patch from the full frame of image data that was cropped from a detection mask as output from the neural network used in detecting one or more passages in the one or more frames of image data.

19. A method for real-time detection and tracking of potential passages in an environment, the method comprising:
computing semantic segmentation of one or more passages in one or more frames of image data;
computing one or more bounding boxes for the one or more passages, wherein the boundary of each of the of the bounding boxes is computed based on edge detection and corner detection of the one or more passages; and
tracking the one or more bounding boxes between two or more frames of image data.

20. A system for real-time detection and tracking of potential passages in an environment, the system comprising:
a. circuitry for detecting one or more passages in one or more frames of image data;
b. circuitry for extracting one or more corners for each of the one or more detected passages;
c. circuitry for tracking one or more points between frames of image data for each of the one or more detected passages in one or more frames of image data; and
d. circuitry for assigning one or more passages detected in a frame of image data to one or more previously-detected passages in a different frame of image data based on a) one or more edges of the one or more detected passages; b) the one or more corners; and c) the circuitry for tracking one or more points between frames of image data for each of the one or more detected passages in the one or more frames of image data.
